(19) United States
(12) Patent Application Publication
(10) Pub. No.: US 2024/0243768 A1
(43) Pub. Date: Jul. 18, 2024

(54) RF COMMUNICATIONS WITH ENHANCED CAPACITY AND SECURITY

(71) Applicant: TM IP HOLDINGS, LLC, Little Switzerland, NC (US)

(72) Inventors: Scott VELAZQUEZ, San Diego, CA (US); Brennan EVELAND, San Diego, CA (US)

(21) Appl. No.: 18/107,901

(22) Filed: Feb. 9, 2023

Related U.S. Application Data
(60) Provisional application No. 63/439,008, filed on Jan. 13, 2023.

(51) Int. Cl. H04B 1/10; H04B 1/12

(52) U.S. Cl. CPC H04B 1/1027; H04B 1/12

(57) ABSTRACT

Systems and methods for enhanced radio frequency (RF) communications include transmitting, with a transmitter, a first RF signal to a receiver through at least one RF channel having a spectral mask. At least a second RF signal is modulated in the transmitter. The modulated second RF signal is transmitted to the receiver through at least one RF channel, and wherein the modulated second RF signal is transmitted at a same time and frequency as the first RF signal. The first RF signal and the modulated second RF signal are received at the same time. The modulated second RF signal is demodulated at the receiver. Signal interference between the first RF signal and the second RF signal is canceled at the receiver.

### CROSS REFERENCE TO RELATED APPLICATION

This application claims benefit of U.S. Provisional Application Ser. No. 63/439,008 entitled, “Cognitive Spectrum Optimization” filed Jan. 13, 2023, the entire disclosure of which is incorporated herein by reference.

### FIELD OF THE DISCLOSURE

The present disclosure is generally related to communication systems and more particularly is related to RF communications with enhanced capacity and security.

### BACKGROUND OF THE DISCLOSURE

Radio Frequency (RF) spectrum is designated by governing bodies to limit the frequency bands that different communications systems are allowed to transmit information in. This is done so that different frequency bands can be used for different applications without having nonidealities of different communication systems interfere with each other. The limit on the available frequency spectrum limits the bandwidth that a communication system can occupy without violating regulation. The limit on bandwidth limits the overall amount of data that can be sent in that spectrum in a given time period. Operators of communication systems want to maximize the data rate and spectral efficiency for the occupied bandwidth, so they can maximize the performance and usability of the communication system operating within that portion of the spectrum.

Improving the data rate and spectral efficiency in a communication system has been important to optimize the usage of radio frequency spectrum. Conventional implementations to improve the spectral efficiency in communication systems include higher order modulation schemes and the use of computationally efficient coding for forward error correction. New modulation techniques like Quadrature Amplitude Modulation (QAM) have modulation orders that determine the number of bits transmitted in a system. Increasing the modulation from 16-QAM to 64-QAM, for example, increases the number of bits transmitted in a signal from 4 bits to 6 bits respectively, thus increasing the spectral efficiency. This improvement is limited by the Shannon limit, which is the theoretical maximum amount of data that can be transmitted error-free for a given amount of noise contamination in the signal. The use of forward error correction coding has also been integral to improving the data rates. Forward error correction has been used to decrease the bit error rate of a given system and can allow for an increase in modulation order, and as a result, an increase in spectral efficiency.

However, despite these improvements in spectral efficiency, many of these techniques have physical limits which prevent spectral efficiency from reaching desired levels. Thus, a heretofore unaddressed need exists in the industry to address the aforementioned deficiencies and inadequacies.

### SUMMARY OF THE DISCLOSURE

Embodiments of the present disclosure provide a system and method for enhanced radio frequency (RF) communications. Briefly described, in architecture, one embodiment of the system, among others, can be implemented as follows. A software defined radio has a transmitter and a receiver in communication through at least one RF channel. The software defined radio executes instructions for: transmitting, with the transmitter, a first RF signal to the receiver through the at least one RF channel having a spectral mask; modulating, in the transmitter, at least a second RF signal; transmitting, with the transmitter, the modulated second RF signal to the receiver through at least one RF channel, wherein the modulated second RF signal is transmitted at a same time and frequency as the first RF signal; receiving, at the receiver, the first RF signal and the modulated second RF signal at the same time; demodulating the modulated second RF signal at the receiver; and cancelling, at the receiver, signal interference between the first RF signal and the second RF signal.

The present disclosure can also be viewed as providing methods of enhanced radio frequency (RF) communications. In this regard, one embodiment of such a method, among others, can be broadly summarized by the following steps: transmitting, with a transmitter, a first RF signal to a receiver through at least one RF channel having a spectral mask; modulating, in the transmitter, at least a second RF signal; transmitting, with the transmitter, the modulated second RF signal to the receiver through at least one RF channel, wherein the modulated second RF signal is transmitted at a same time and frequency as the first RF signal; receiving, at the receiver, the first RF signal and the modulated second RF signal at the same time; demodulating the modulated second RF signal at the receiver; and cancelling, at the receiver, signal interference between the first RF signal and the second RF signal.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagrammatical illustration of a system of enhanced RF communications, in accordance with embodiments of the present disclosure.

FIG. 2 is a diagrammatical illustration of the system of enhanced RF communications, in accordance with embodiments of the present disclosure.

FIG. 3 is a diagrammatical illustration of a transmitter used with the system of enhanced RF communications, in accordance with embodiments of the present disclosure.

FIG. 4 is a diagrammatical illustration of the DSP block of the transmitter used with the system of enhanced RF communications, in accordance with embodiments of the present disclosure.

FIG. 5 is a diagrammatical illustration of the modulation block of the transmitter used with the system of enhanced RF communications, in accordance with embodiments of the present disclosure.

FIG. 6 is a diagrammatical illustration of the receiver used with the system of enhanced RF communications, in accordance with embodiments of the present disclosure.

FIG. 7 is a diagrammatical illustration of the DSP block of the receiver used with the system of enhanced RF communications, in accordance with embodiments of the present disclosure.

FIG. 8 is a diagrammatical illustration of the enhanced demodulator of the receiver used with the system of enhanced RF communications, in accordance with embodiments of the present disclosure.

FIG. 9 is a diagrammatical illustration of the signal interference cancellation block of the receiver used with the system of enhanced RF communications, in accordance with embodiments of the present disclosure.

FIG. 10 is a diagrammatical illustration of an exemplary transceiver showing a transmission process which may be used with the system of enhanced RF communications, in accordance with embodiments of the present disclosure.

FIGS. 11-15 are graphical images of a constellation model, in accordance with embodiments of the present disclosure.

FIG. 16 is a diagrammatical illustration of an exemplary transceiver showing a receiving process which may be used with the system of enhanced RF communications, in accordance with embodiments of the present disclosure.

FIGS. 17-20 are graphical images of a constellation model, in accordance with embodiments of the present disclosure.

### DETAILED DESCRIPTION

Despite the existence of some improvements in spectral efficiency, as discussed previously, there is a need for further solutions which provide increased spectral efficiency. Communications capacity is often limited by the signal-to-noise ratio (SNR) of a system and the communications channel, i.e., the Shannon limit. This physical limit puts a cap on the available spectral efficiency that a communication system can realistically use.

One general technique to further increase spectral efficiency uses Transpositional Modulation (TM), which is a RF waveform technology that can offer significant bandwidth increases for existing wireless and wired networks. These bandwidth increases are accomplished by enabling the simultaneous transmission of two or more distinct data paths on a single carrier signal, which increases the efficiency of the carrier wave. Moreover, the benefits of TM in radio communications provide a new method of carrier signal modulation and works as a foundational waveform. Additionally, TM can provide for overlaying one type of modulation on top of another with very low, near zero, increases in interference or noise. TM has also been proven to function well with existing compression, encryption, or coding methods. This transparency is compatible even with complex modulations such as QAM, n-phase shift keying (n-PSK), and orthogonal frequency-division multiplexing (OFDM). Because of its transparency and ultra-efficient characteristics, TM allows the transmission of two or more signals simultaneously instead of one signal, as with other modulations, all without destroying the integrity of the individual bit streams.

More specifically, this disclosure may utilize TM techniques which use signal cancellation to reduce noise and interference, thereby allowing for more data to be sent over the same channel at the same time than conventional communications systems. In particular, the TM techniques described herein can be used to adaptively exploit SNR headroom in a communication system which adds communications capacity while staying within regulatory limits. Additionally, TM techniques may optionally allow for the use of additional signals that can provide obfuscated communications for sensitive information, e.g., encryption keys, command/control/communications, etc. in contested environments. While indiscriminately adding waveforms to conventional communications systems can adversely affect the spectral spreading and SNR of the system and present significant co-channel interference problems, TM cognitively adds non-interfering, orthogonal channels of communication to legacy communications systems to enable sizeable increases in data rates without interfering with or degrading the original, legacy communications.

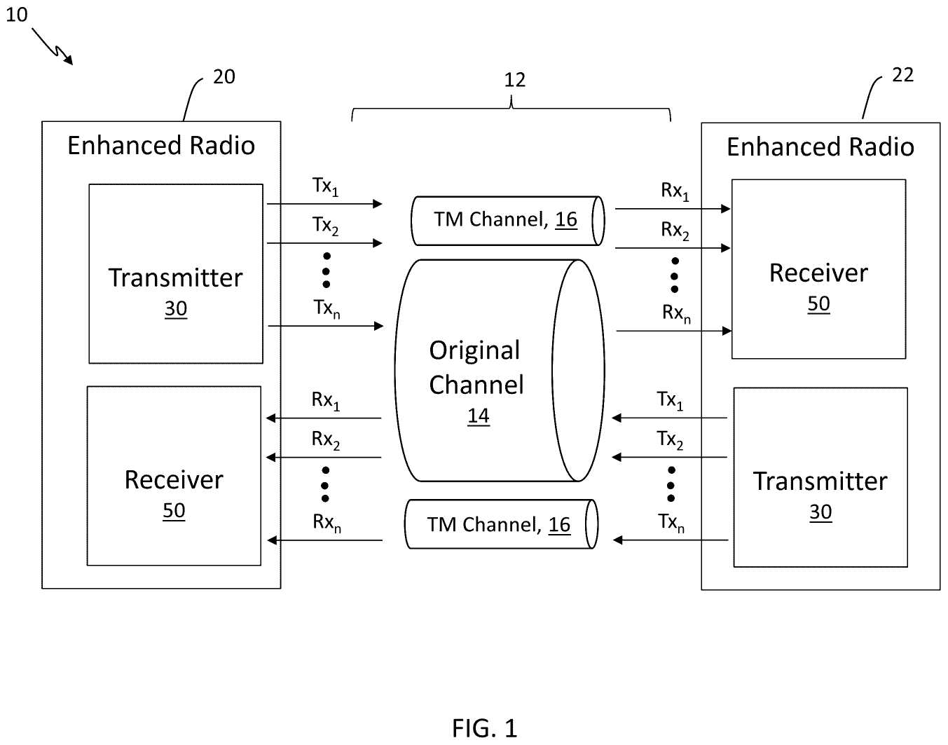

Technologies described herein allow for increased efficiency of using the RF spectrum that current communication systems occupy. To this end, FIG. 1 is a diagrammatical illustration of a system of enhanced RF communications 10, in accordance with embodiments of the present disclosure. The system of enhanced RF communications 10, which may be referred to herein simply as ‘system 10’ include one or more radios 20, 22, each of which has at least one transmitter 30 and at least one receiver 50. It is noted that FIG. 1 depicts the system 10 in full duplex operation, however, it is possible to utilize the system 10 in a single direction. The radios 20, 22 are in communication through at least one communication system or communication network 12. As depicted in FIG. 1, the communication network 12 may include an original channel 14 having a spectral mask, and one or more additional channels 16. These additional channels may be TM channels 16 which operate within the spectral mask of the original channel 14, such that signals transmitted within the TM channels 16 do not exceed the spectral mask of the original channel 14.

In general operation, data is transferred through one transmitter, sent over a channel, and recovered by a receiver in a different radio. More specifically, the operation may include transmitter 30, e.g., transmitter 30 of radio 20 transmits a first RF signal (Tx₁) to a receiver 50, e.g., receiver 50 in radio 22. The signal is transmitted through the original channel 14, which may be a conventional carrier channel. Within the transmitter 30 of radio 20, at least one second RF signal (Tx₂), but including any number of second RF signals as denoted by Txₙ, are modulated. The data signal is modulated to improve the spectral efficiency of the bandwidth occupied by the transmitted RF signal. In particular, the system 10 may modify the transmitter 30 to allow one or more additional radio frequency signals to be transmitted at the same time and frequency of the original signal, e.g., through one or more of the original channel 14 and/or the TM channels 16. This signal may be referred to as a composite signal, and the vectors for the in-phase and quadrature components of this composite signal may be derived from the following equation:

$$< A c os {θ}_{n} + B cos {σ}_{n} , A s in {θ}_{n} B + B sin {σ}_{n} >$$

$$for {θ}_{n} , {σ}_{n} = \frac{π}{4} , \frac{3 π}{4} , \frac{5 π}{4} , \frac{7 π}{4}$$

These signals may be transmitted through the original channel 14, a TM channel 16, or another channel to be recovered by a receiver 50, e.g., denoted as Rx₁ and Rx₂ through Rxₙ, which correspond to the transmitted signals Tx₁ and Tx₂ through Txₙ. For instance, the one or more modulated signals Tx₂ through Txₙ are transmitted to the receiver 50 of the second radio 22 through at least one RF channel, whether the original channel 14, a TM channel 16, or another RF channel, whereby the signals Tx₂ through Txₙ do not exceed the spectral mask of the RF channel 14. It is noted that these signals Tx₂ through Txₙ are transmitted at the same time or simultaneously, and at the same frequency as the first RF signal Tx₁. The transmission of this additional signal (or additional signals) at the same time and frequency as the original signal causes the signals to interfere with each other and the signals transmitted will not match the signals that were received. When received, the system 10 may modify the receiver 50 of radio 22 to recover both the original signal Tx₁ and the additional signal Tx₂ through Txₙ sent by the transmitter. In general terms, this may be achieved by cancelling the additional signal Tx₂ through Txₙ from the original signal Tx₁ and similarly canceling the original signal Tx₁ from the additional signal Tx₂ through Txₙ to demodulate each received signal and correctly recover both transmitted signals. This may achieve the desired signal interference cancellation between the signals.

The additional signals Tx₂ through Txₙ transmitted may be sent at a lower power level relative to the original signal Tx₁. While signal interference cancellation techniques are used to cancel the interference from the original signal, the underlying additional signals may feel greater effects from noise and intermodulation distortion. To overcome the decreased signal to noise ratio, it may be possible to use a combination of forward error correction coding and custom averaging of redundant sets of data to reduce the effects of noise on the system and improve the bit error rate. Oversampling can also be used to attain redundant data sets to improve the signal to noise ratio as well. Additionally, custom linearization and digital predistortion techniques can be used to decrease the effects of intermodulation distortion on the system. The overall result is an improvement in the data rate and spectral efficiency of a communication system without using additional bandwidth in a given radio frequency spectrum and without interfering with the original signal.

With regards to linearization, custom digital pre-distortion (DPD) linearization techniques may be used to increase the room under the emissions mask by removing intermodulation distortion. For instance, an efficient adaptive digital pre-distortion can be used to provide spectral headroom within regulatory mask requirements to allow the addition of one or more TM signals. This multi-dimensional compensator may effectively mitigate linear and nonlinear distortion in RF power transmitter electronics by modeling the state of the device by tracking multiple functions of the input. This can include, for instance, the present input signal value; delayed values of the input (for memory effects); derivatives of the input (including higher order derivatives); integration of the input (including higher order integrals); signal statistics (e.g., mean, variance); current power level (RMS or peak); and polynomial functions of the input. The processing may be implemented with memory instead of digital multipliers for low-power applications. It may be calibrated using arithmetic operations that can be completed with low processing requirements and very quickly to track parameters that rapidly change over time, temperature, and power level such as in frequency-hopping systems. Additionally, it can be implemented in hardware without the use of any digital multipliers and operates at very wide instantaneous bandwidths (e.g., >1 GHz instantaneous bandwidth).

The improvement in the data rate and spectral efficiency of a communication system may be quantified by the following equation:

$$\% Improvement = \frac{( \frac{{n Data}_{Orbital}}{Redundancy} ) * \frac{\begin{matrix}{SNR}_{measured} - {Orbital}_{Atten} - \\ {SNR}_{min} + 3 * {log}_{2} ( Redundancy )\end{matrix}}{Δ SNR}}{{n Data}_{legacy} * {M}_{legacy}}$$

where percent improvement in achievable data rate (% Improvement) is quantified as a function of the current measured SNR of the system (SNR_{measured}), the allowable attenuation of the added Overlay TM signal (Orbitalₐₜₜₑₙ), the minimum SNR required for the specified modulation density (SNRₘᵢₙ), the data redundancy used for averaging (Redundancy), the delta SNR corresponding to the difference in modulation density (ΔSNR), and the number of legacy system subcarriers (nData_{legacy}).

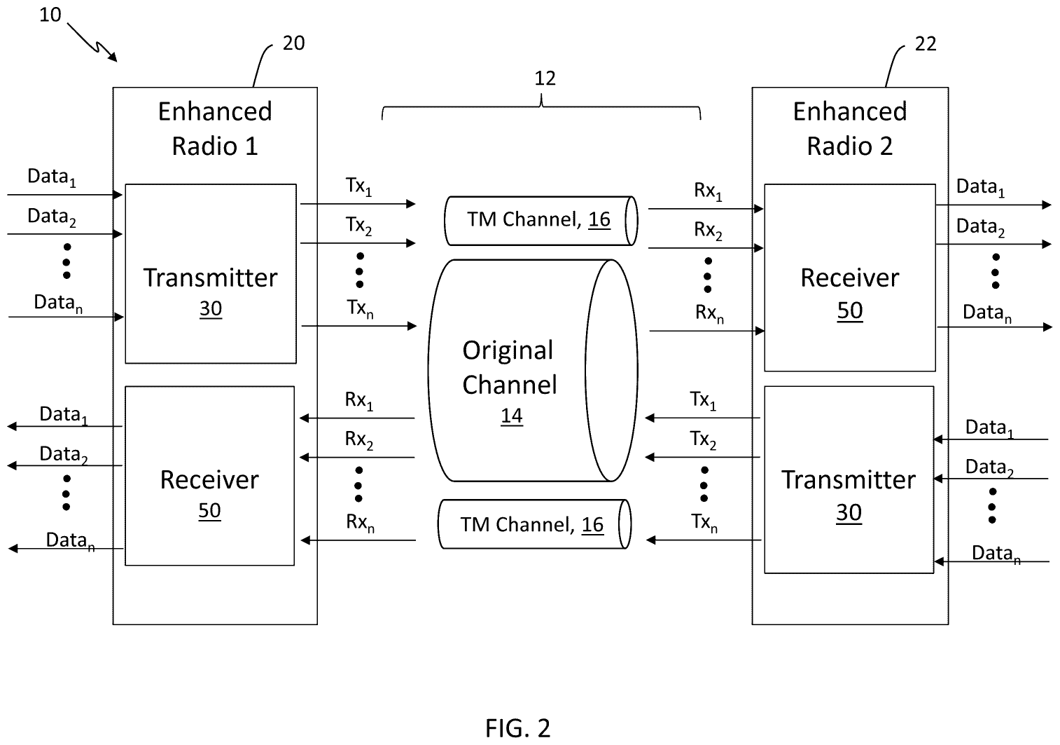

FIGS. 2-9 provide additional details on components, features, and functionality of the system 10.

FIG. 2 is a diagrammatical illustration of the system of enhanced RF communications 10, in accordance with embodiments of the present disclosure. As shown in FIG. 2, multiple additional sets of data, e.g., Data₂ through Dataₙ, may be able to be sent into the enhanced transmitter 30 simultaneously alongside the original set of data, e.g., Data₁. These sets of data may feed into the enhanced transmitter 30 and are transmitted on a single carrier frequency, such as on the original channel 14 for the original data set and for the additional data sets. The data sets are then able to be received by the enhanced receiver 50 of radio 22, and the output is the multiple sets of data Data₁, and Data₂ through Dataₙ that were transmitted.

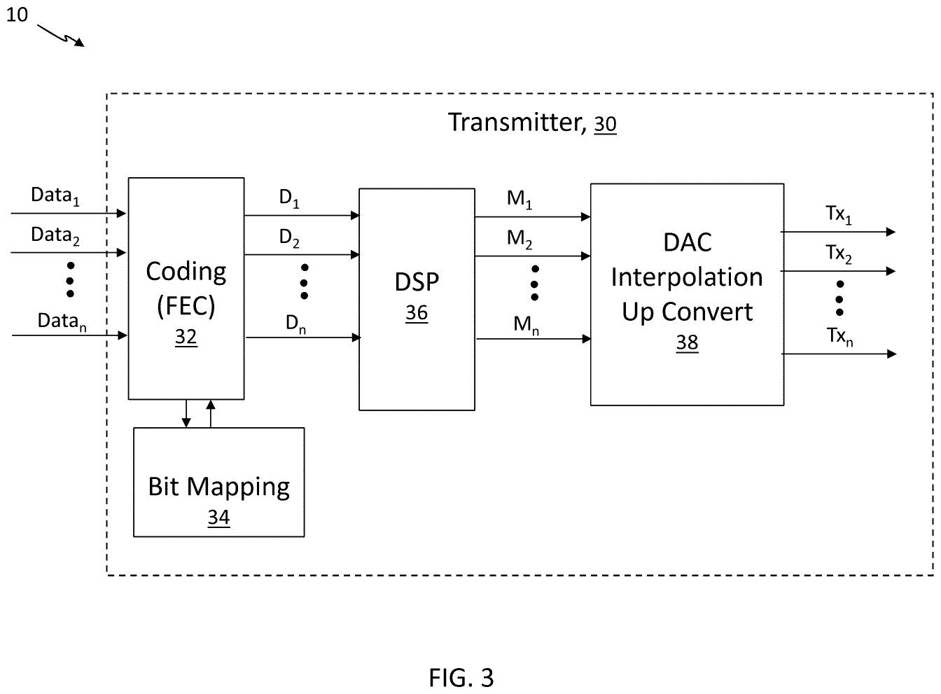

FIG. 3 is a diagrammatical illustration of a transmitter 30 used with the system of enhanced RF communications 10, in accordance with embodiments of the present disclosure. As shown in FIG. 3, the enhanced transmitter 30 may receive, as inputs, the original data sets Data₁, and multiple additional data sets Data₂ through Dataₙ, which are able to be transmitted simultaneously. All sets of data may be passed into a coding block 32, such as, for example low density parity check code, for processing forward error correction (FEC). At this stage, bit mapping at block 34 may also occur for the additional signals to improve signal recovery at the receiver. The coded sets of data (D₁ and D₂ through Dₙ) are then passed into a Digital Signal Processing (DSP) block 36 that outputs the digital signals (M₁ and M₂ through Mₙ) that will eventually be transmitted to the receiver. These digital signals may be combined at this stage and processed through the digital-to-analog converter (DAC), interpolator, and up converter block 38 to create the time domain signal on a radio frequency carrier. In one of many alternatives, each distinct signal could have their own DAC block and be transmitted simultaneously on the same radio frequency carrier.

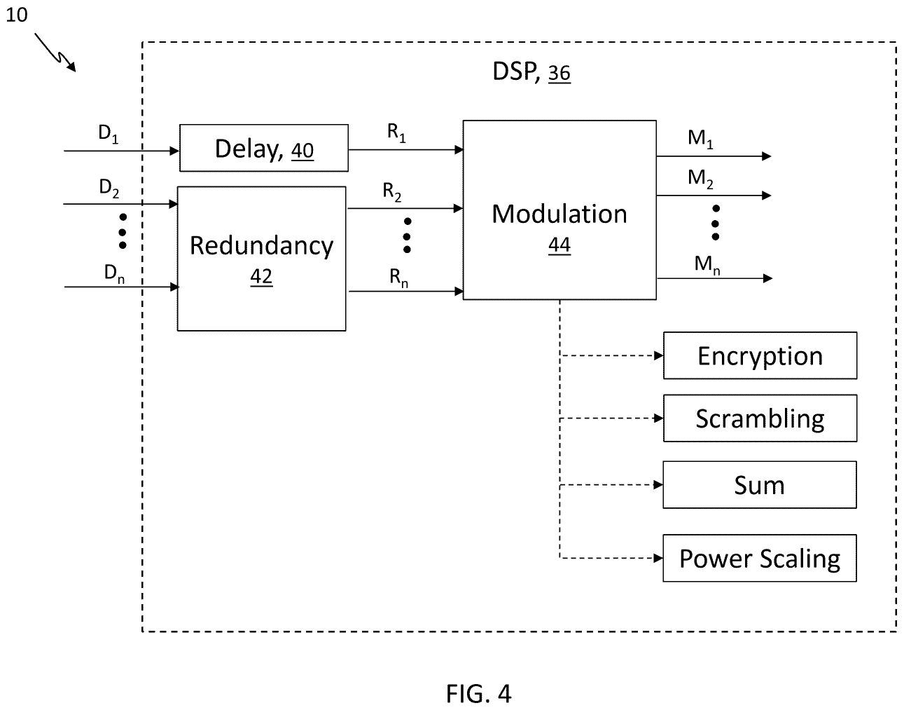

FIG. 4 is a diagrammatical illustration of the DSP block 36 of the transmitter 30 used with the system of enhanced RF communications 10, in accordance with embodiments of the present disclosure. In particular, FIG. 4 illustrates system enhancements for the transmitter 30. The FEC sets of data, e.g., D₁ and D₂ through Dₙ are the inputs to the DSP block 36. The original set of data D₁ may be delayed at block 40 to account for the redundancy block 42 that the additional sets of data D₂ through Dₙ pass through. The redundancy block 42 may process the additional data sets D₂ through Dₙ into smaller blocks of data. These smaller blocks of data are then repeated to create new sets of data, which is identified in FIG. 4 as R₂ through Rₙ. These new sets of data R₂ through Rₙ are the same size as the original signal R₁. The size of the smaller blocks of data R₂ through Rₙ and the amount of repetition may depend on the channel conditions of the system 10 and the power scaling that is applied to the additional signals R₂ through Rₙ. The delayed original signal R₁ and the redundant additional signals R₂ through Rₙ are inputs to the enhanced modulator 44. The output of the enhanced modulation block 44 are signals M₁ and M₂ through Mₙ, which are digital time domain baseband signals.

Additional and optional processing blocks may also be employed. For example, optionally, the data M₁ and M₂ through Mₙ can be encrypted, scrambled, added, and power scaled in the DSP block. Notably, the modulated signals M₁ and M₂ through Mₙ can be added together in order to transmit the signal using a single DAC block instead of each additional signal requiring their own DAC block. The additional signals M₂ through Mₙ may also be power scaled down to reduce interference with the original signal M₁. This can occur by multiplying M₂-Mₙ by scaling factors digitally. It may also be possible to use a hardware attenuator to scale the RF signal or signals.

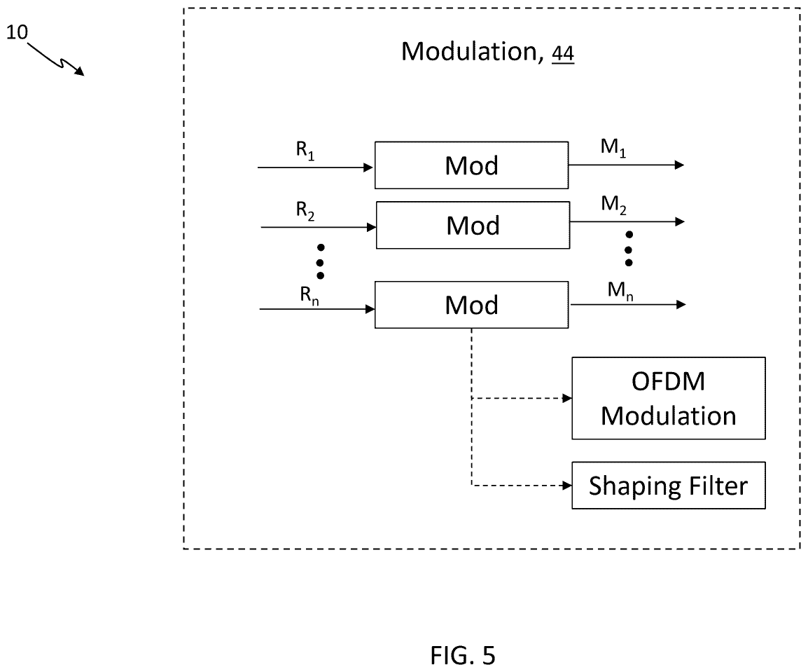

FIG. 5 is a diagrammatical illustration of the modulation block 44 of the transmitter 30 used with the system of enhanced RF communications 10, in accordance with embodiments of the present disclosure. As shown, the original signal R₁ may use a modulation scheme, such as that which is conventionally employed, depending on the application. This may include Binary phase-shift keying (BPSK), Quadrature Phase Shift Keying (QPSK), Amplitude and phase-shift keying (APSK), Quadrature Amplitude Modulation (QAM), or another modulation technique, or a combination thereof. The additional signals R₂ through Rₙ may have their own modulators and can optionally match the modulation technique of the original signal R₁. In this case, each signal will then have their own shaping filter or Orthogonal Frequency-Division Multiplexing (OFDM) modulation applied when applicable. It is noted that in FIG. 5, each signal is depicted with a separate modulator, but it is possible for two or more signals to use one modulator.

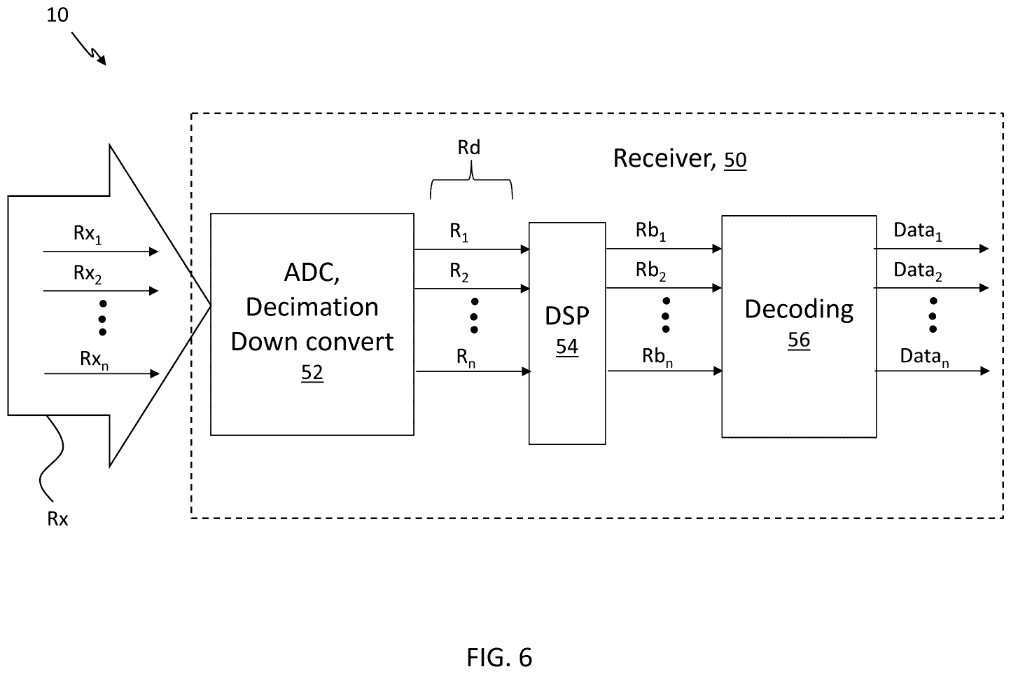

The signals transmitted by the enhanced transmitter, e.g., Tx₁ and Tx₂ through Txₙ, as depicted in FIG. 3, are communicated through one or more of the original channel 14 or the TM channels 16, as shown in FIGS. 1-2, and will be captured by the enhanced receiver 50 depicted in FIGS. 1-2. The receiver 50 is depicted in detail in FIG. 6, which is a diagrammatical illustration of the receiver 50 used with the system of enhanced RF communications 10, in accordance with embodiments of the present disclosure. The signals Rx₁ and Rx₂ through Rxₙ will be received as a single signal Rx because the signals can either be combined digitally into a single signal before being transmitted from the transmitter 30, or they will combine as RF waves when they are simultaneously transmitted. The received RF signal Rₓ is down converted in frequency to baseband, decimated, converted to a digital signal using an analog-to-digital converter (ADC) at block 52. The signals, R₁ and R₂ through Rₙ, which are now digital signal, Rd, go into a digital signal processing (DSP) block 54 where the main signal R₁, as well as the additional signals R₂ through Rₙ are recovered and output as signals Rb₁, and Rb₂ through Rbₙ. These signals can then be decoded by the error correcting decoder 56 to improve the bit error rate and recover each of the transmitted data sets Data₁, and Data₂ through Dataₙ.

It is noted that custom coding techniques may be used to enhance the bit error rate of the added TM signals, which may be important since the additional TM signals are attenuated and in the presence of noise, distortion, and interference in congested environments. For example, Intelligent Poly Key (IPK) Zero Overhead Encode (ZOE) is an enhanced coding technique with the extra benefit of Physical Layer encryption via dynamically changing codes (vs. static codes that provide no security benefits). IPK ZOE is a secure method of encoding the data transmission between nodes on wireless and wired networks. The throughput energy per bit needed for the link is decreased by the gain of the forward error correcting code while the physical layer data is secured by constantly changing codes. This provides physical layer security because the transmitted symbols cannot be decoded from the noise without knowing a priori the current chosen Quasi-Cyclic Low Density Parity Check prototype matrix.

Standard communications use Quasi-Cyclic Low Density Parity Check (QC-LDPC) codes using Proto Graph based code construction to create the Generator Matrix. The main reason for using these codes is the efficiency of encoding and the relative efficiency of decoding and the relative efficiency of a decoder implementation using belief-propagation-based decoding algorithms. The codes, however, are static for a particular data rate and Physical Layer modulation type. IPK ZOE generates codes using the same type of geometry but using a key schedule to drive the exact proto graph used and synchronizing the transmitter and receiver using the Intelligent Poly Key (IPK) protocol. These methods produce codes that are as efficient as those in use by any system but with the added benefit of physical layer symbol security.

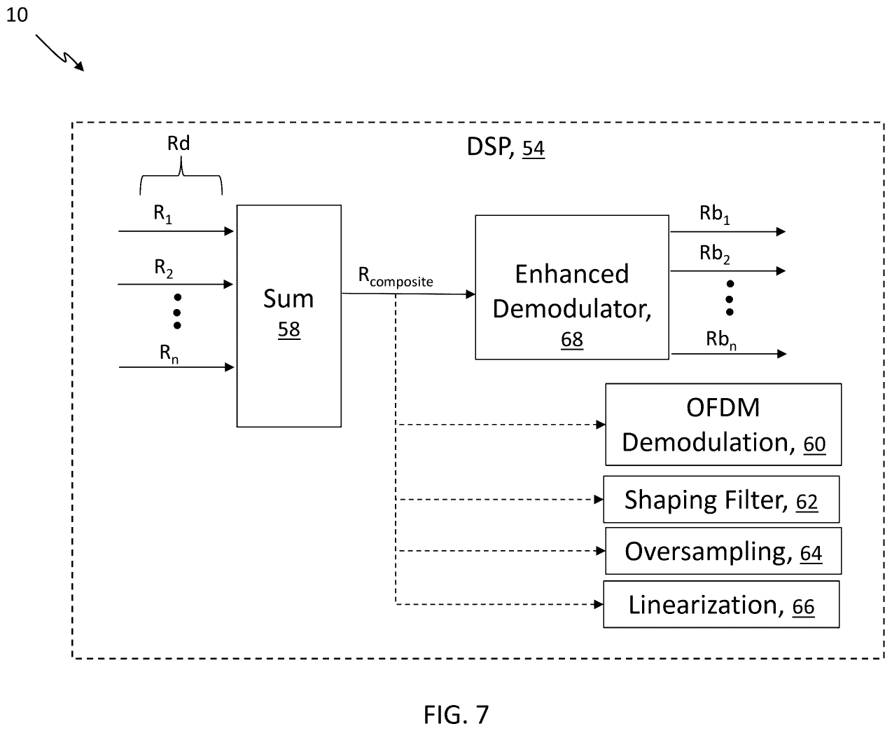

FIG. 7 is a diagrammatical illustration of the DSP block 54 of the receiver 50 used with the system of enhanced RF communications 10, in accordance with embodiments of the present disclosure. The input to the DSP block 54 is the received digital signal Rd having signals R₁ and R₂ through Rₙ, which is the outputs of the ADC block 52. These signals may be combined at block 58 to form a composite signal R_{composite}. Next the R_{composite} signal may be processed in an OFDM demodulation block 60 for an OFDM system. Optionally, the R_{composite} signal may also be processed in additional processing blocks, such as shaping filters 62, an oversampling block 64, and a linearization block 66. The signal may then be passed into the enhanced demodulator block 68 where the signals are demodulated and the original signal and additional signals are recovered. The output of the enhanced demodulator 68 are the received demodulated coded signals, Rb₁ and Rb₂ through Rbₙ.

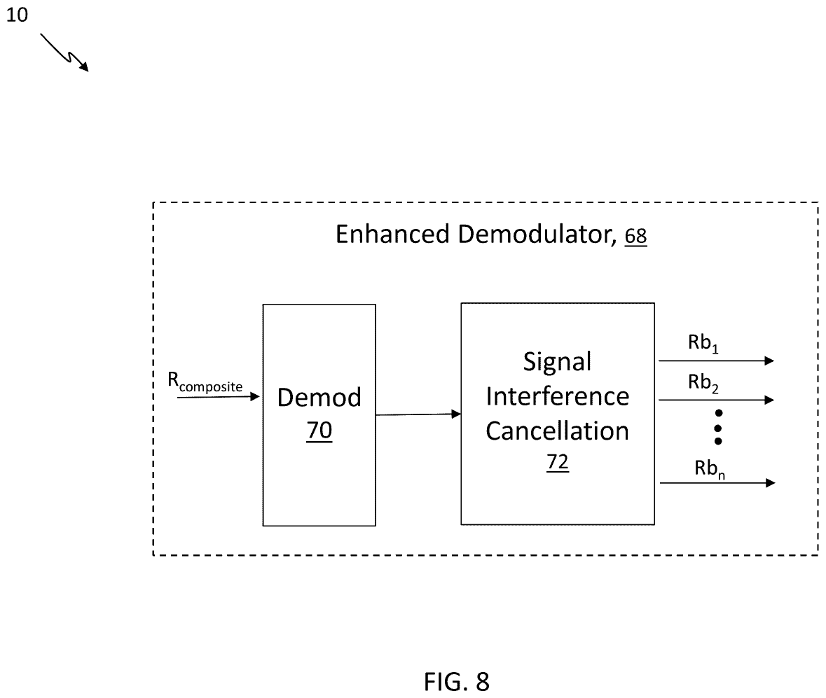

The enhanced demodulator 68 is described in detail in FIG. 8, which is a diagrammatical illustration of the enhanced demodulator 68 of the receiver 50 used with the system of enhanced RF communications 10, in accordance with embodiments of the present disclosure. As shown, the enhanced demodulator may include two processing blocks, namely, a standard demodulator 70 and a signal interference cancellation block 72. The standard demodulator block 70 may demodulate the received R_{composite} signal and may be a BPSK, QPSK, QAM, or other type of demodulator, or combination thereof. This demodulated signal then goes into the signal interference cancellation block 72 where the single received signal will get separated into the original signal Rb₁ and additional signal(s) Rb₂ through Rbₙ.

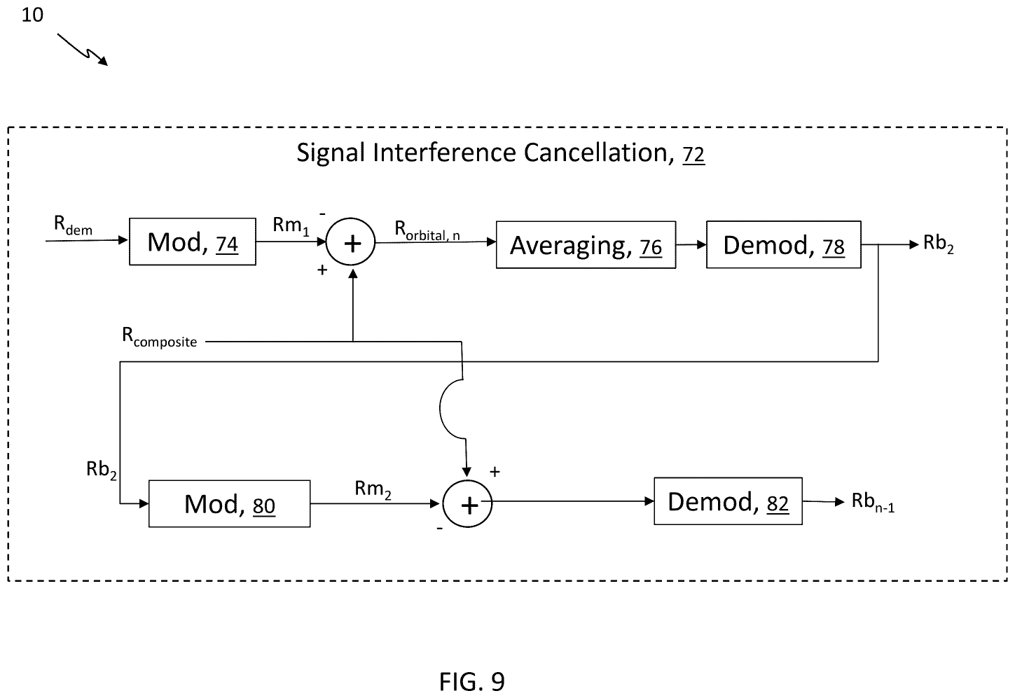

FIG. 9 is a diagrammatical illustration of the signal interference cancellation block 72 of the receiver 50 used with the system of enhanced RF communications 10, in accordance with embodiments of the present disclosure. As shown, the input to the signal interference cancellation block is the demodulated received composite signal R_{dem} from demodulator 70, per FIG. 8. The R_{dem} signal is then remodulated using a modulating block 74 that matches the modulation of the standard demodulation block used, e.g., demodulator block 70. This remodulated signal Rm₁ may provide an estimated original signal without any noise or distortion. Rm₁ is then subtracted from the received composite signal, R_{composite}. The subtraction substantially cancels the original signal from the composite signal, leaving the additional signals, noise and distortion, as indicated at the R_{orbital, n} signal. It is noted that substantially canceling the original signal from the composite signal may be understood as ideally canceling all parts of the original signal with a de minimus amount of the original signal remaining.

The redundant data sets in R_{orbital, n} signal are then input to an averaging block 76 that reduces the noise in the R_{orbital, n} signal. This averaged R_{orbital, n} signal can then be demodulated using a standard demodulated block 78 matching the modulation scheme for the first additional signal in the transmitter 30. The output is the received coded first additional signal, Rb₂. This Rb₂ signal may then be remodulated using a standard modulation block 80 matching the one in the transmitter 30. The remodulated signal Rm₂ is then subtracted from the received composite signal, R_{composite}, and the resultant signal is the received modulated original signal. This signal is demodulated at block 82, again using a demodulator matching the modulation scheme of the original signal, and the coded original signal, Rb₁, is recovered. It is noted that this process can then be repeated for any other additional signals transmitted, e.g., Txₙ in FIGS. 1-3. In this case, signal R_{dem} would now be equal to Rb₂ and the outputs would be Rb₃ and Rb₂. For the additional signal transmitted Dataₙ, the input would be Rbₙ₋₁ and the output of the signal interference cancellation block would be Rbₙ and Rbₙ₋₁.

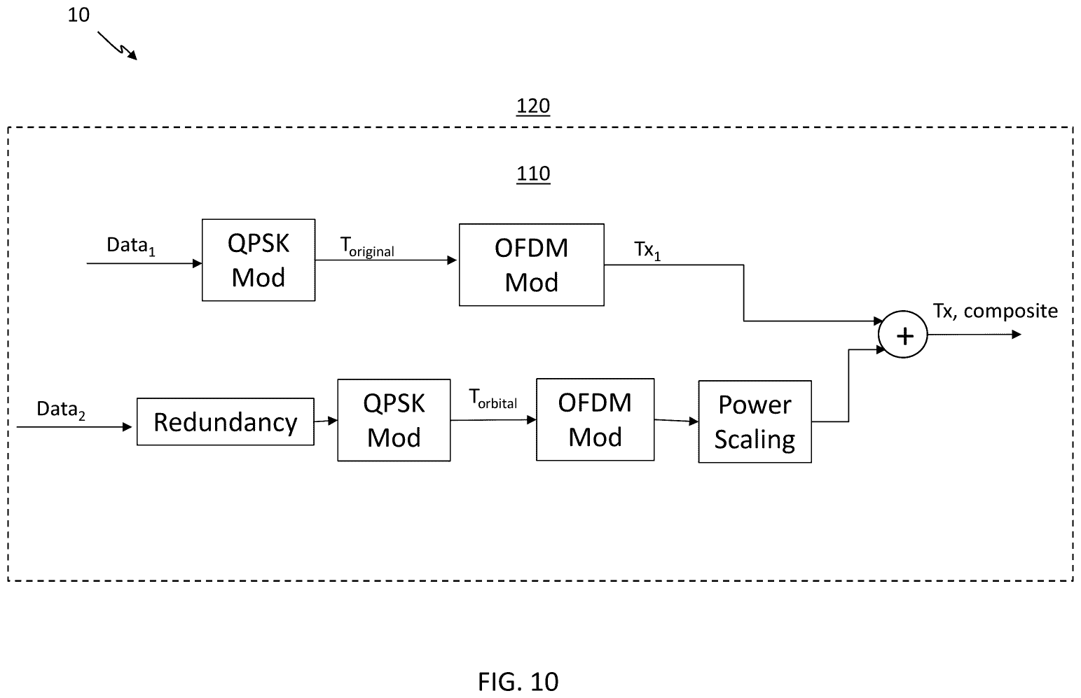

To provide further clarity in disclosure, FIG. 10 is a diagrammatical illustration of an exemplary transceiver 110 showing a transmission process 120 which may be used with the system of enhanced RF communications 10, in accordance with embodiments of the present disclosure. In particular, the example of FIG. 10 incorporates the original signal, Data₁, and one additional signal, Data₂. The exemplary transceiver 110 uses OFDM modulation and QPSK modulation, but is it noted that neither OFDM or QPSK modulations are required, as other modulation techniques could also be employed, such as QAM, BPSK, APSK, or others.

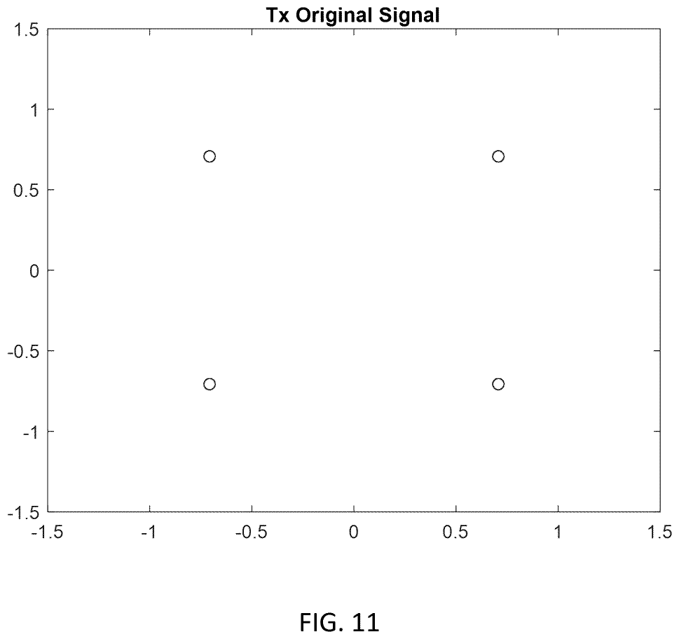

Data₁ is the original signal, which may include, in one example, 80 OFDM symbols with each symbol having 148 active data subcarriers, but it is noted that other numbers of OFDM symbols or data subcarriers may be used. Data₂ is the additional signal that will be used to create the orbital signal. In this example, Data₂ includes 80 OFDM symbols with each symbol containing 148 active data subcarriers, but these parameters could be different. Data₁ and Data₂ may both be QPSK modulated, meaning that each QPSK symbol will contain two bits of information, but the number of bits per symbol may be dependent on the modulation scheme and order. Data₁ is QPSK modulated and the resulting constellation is shown in FIG. 11, which is a graphical image of a constellation model, in accordance with embodiments of the present disclosure. Specifically, FIG. 11 illustrates the original signal QPSK constellation to be transmitted, which is the output of the QPSK modulation block in the example of FIG. 10. The input is the Data₁ bits, and the output is the QPSK modulated data, T_{original}. The digital QPSK signal is comprised of an in-phase (real) component and quadrature (imaginary) component. The constellation plot shows each pair of bits' modulated data vector plotted on a complex axis.

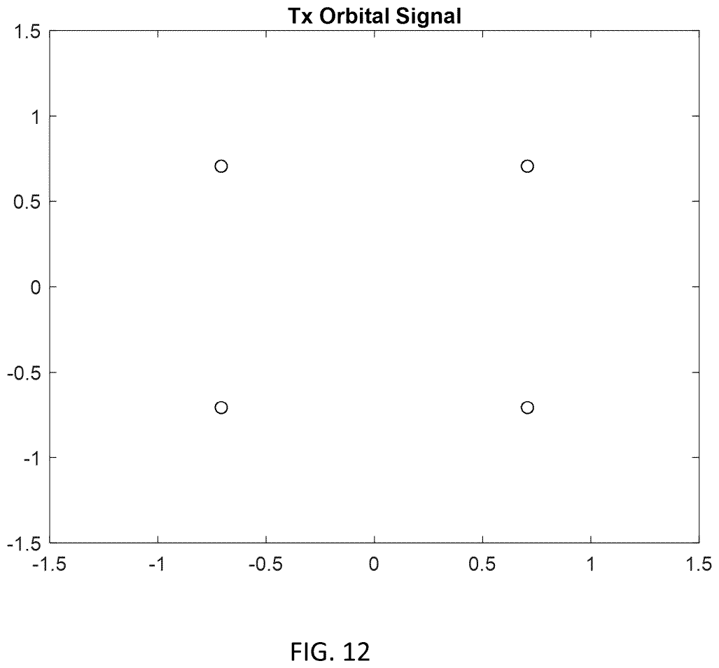

Referring back to FIG. 10, Data₂ is truncated to contain 74 subcarriers per OFDM symbol, in this example, but the data could be truncated more or less. The data contained in Data₂ is then repeated to again contain 148 data subcarriers per OFDM symbol where the first 74 subcarriers are equal to the second 74 subcarriers. This is one method of truncating the signal and repeating the data but other methods of truncation and repetition can also be used. For instance, the data could be truncated by the number of OFDM symbols instead where signal is 40 OFDM symbols and the first 40 symbols are repeated to create an 80 symbol signal. The truncation and repetition don't necessitate that the symbols or subcarriers be truncated and repeated in linear or any other order. The redundant signal is then QPSK modulated to create the Orbital signal. The resulting constellation is shown in FIG. 12, which is a graphical image of a constellation model, in accordance with embodiments of the present disclosure. Specifically, FIG. 12 illustrates the orbital signal QPSK constellation to be transmitted before power scaling. The input is the Data₂ bits, and the output is the QPSK modulated data, T_{orbital}. The digital QPSK signal is comprised of an in-phase (real) component and quadrature (imaginary) component. The constellation plot shows each pair of bits' modulated data vector plotted on a complex axis.

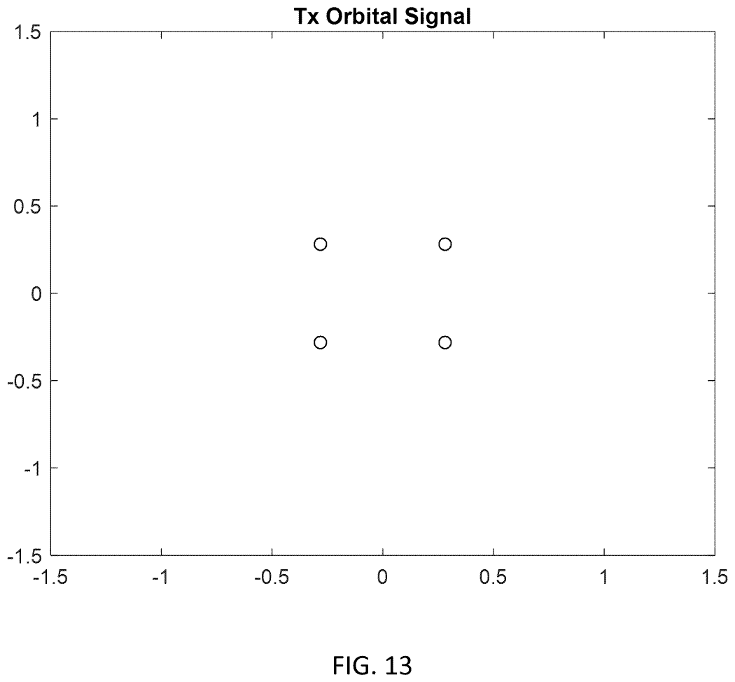

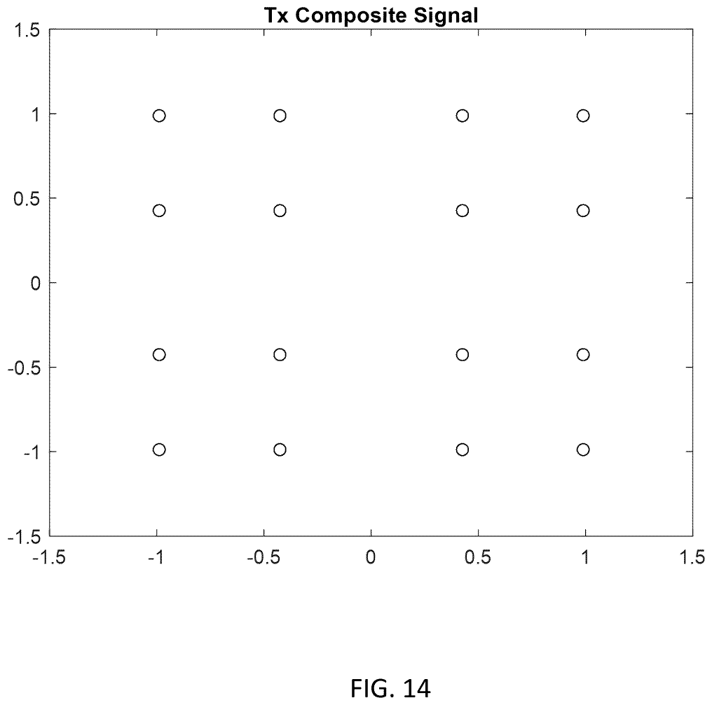

FIG. 13 is a graphical image of a constellation model, in accordance with embodiments of the present disclosure, which depicts the constellation if the power scaling is done after the QPSK modulation, but before the OFDM modulation. In FIG. 10, the power scaling is done after the OFDM modulation, but the result is the same if it is done after the QPSK Modulation block. FIG. 14 shows the effect of power scaling the QPSK. It is noted that the subject disclosure does not require power scaling to occur at this point in the system, but power scaling the QPSK modulated signal may better demonstrate the composite signal constellation. This is shown in FIG. 14, which is a graphical image of a constellation model, in accordance with embodiments of the present disclosure, specifically, a model of the composite signal constellation to be transmitted after Orbital signal power scaling. This is the sum of the QPSK signals in FIG. 11 and FIG. 13. The plotted constellation is representative of the transmitted composite signal in FIG. 10, Tx,_{composite}. In FIG. 10, the composite signal is the sum of the OFDM signals, but the result would be the same if the addition was done to the power scaled QPSK signals as seen in this figure.

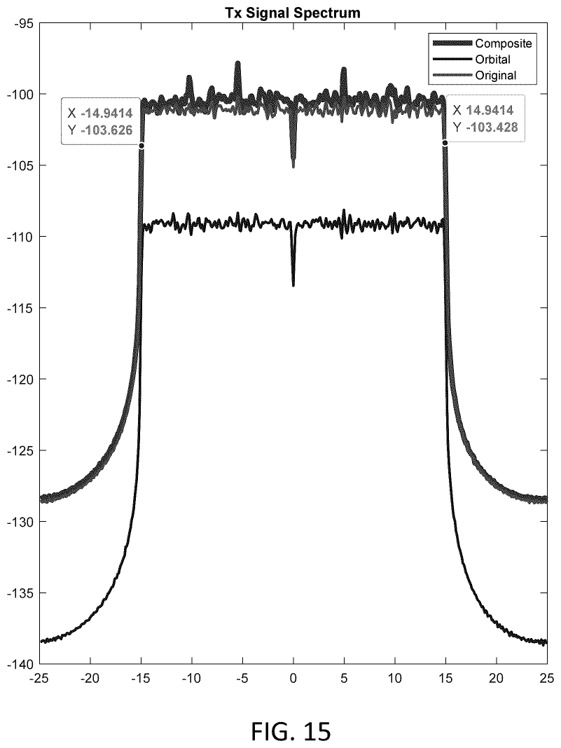

Next, FIG. 15 is a graphical image of a constellation model, in accordance with embodiments of the present disclosure, which depicts the frequency spectrum of the composite OFDM signal, i.e., the transmitted OFDM signal frequency spectrums. This is the frequency spectrum of the output signal Tx,_{composite} in FIG. 10, plotted on a logarithmic scale. The purple signal is the composite signal mentioned while the red signal is the OFDM original signal, Tx₁, and the blue signal is the OFDM orbital signal after power scaling. The composite signal is slightly higher in power than the original signal while the orbital signal is attenuated while occupying the same frequency spectrum as the original.

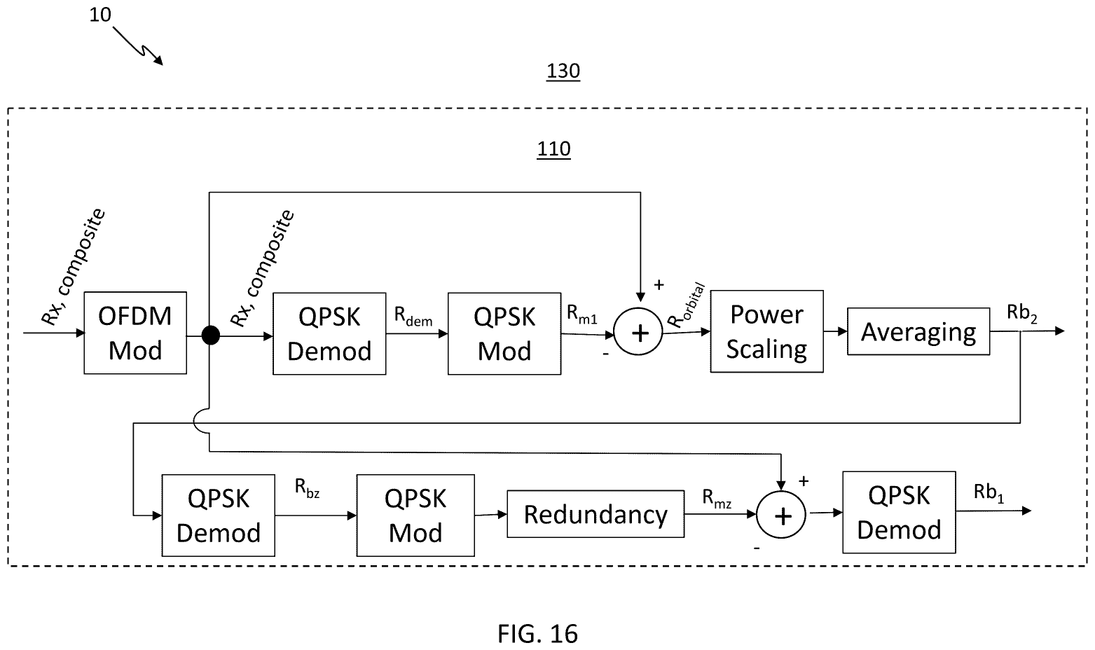

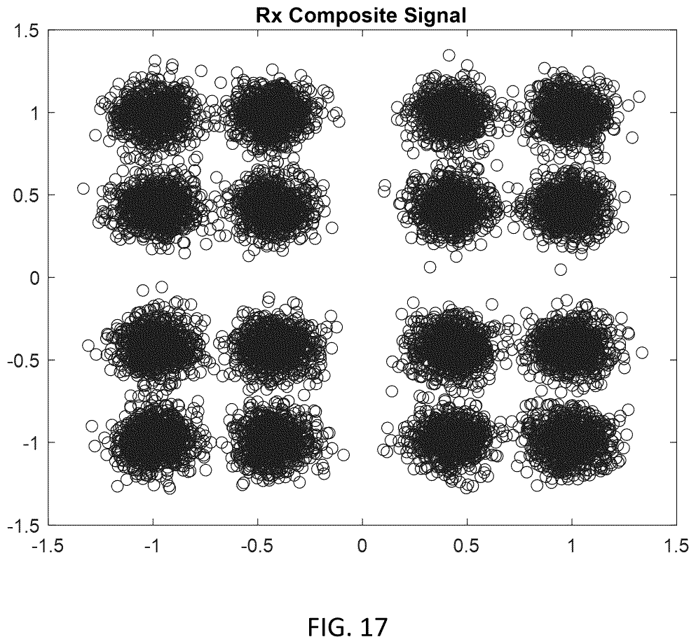

Continuing with the previous example, FIG. 16 is a diagrammatical illustration of an exemplary transceiver 110 showing a receiving process 130 which may be used with the system of enhanced RF communications 10, in accordance with embodiments of the present disclosure. As shown in FIG. 16, the composite signal, RX_{composite}, is transmitted through a channel (AWGN in this case) and received by the receiver. The composite signal RX_{composite} is OFDM demodulated resulting in the noisy composite modulated signal. FIG. 17, which is a graphical image of a constellation model, in accordance with embodiments of the present disclosure, shows the constellation plot of the received composite signal. More specifically, FIG. 17 shows the received composite signal with AWGN channel and a SNR=16 dB. The result is the noisy composite QPSK signals.

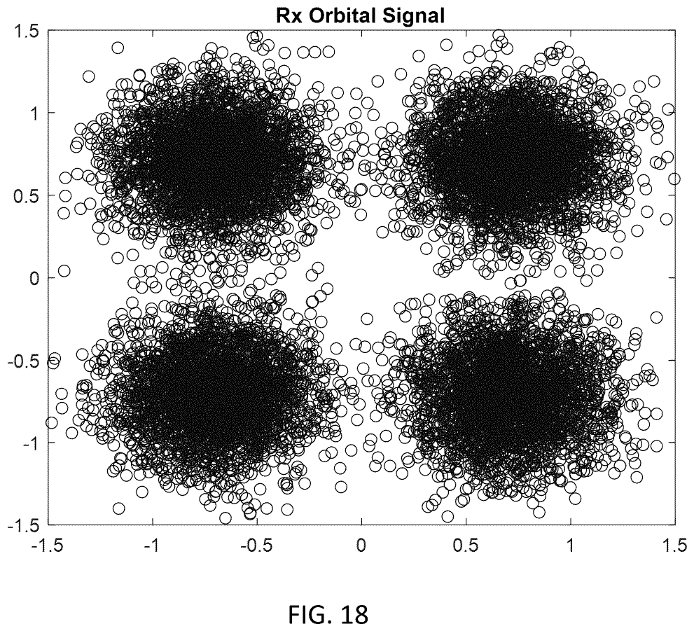

This signal is then QPSK demodulated, then remodulated to give an estimate of the original QPSK signal. This estimated signal is then subtracted off from the received composite signal to recover the noisy Orbital Signal. FIG. 18, which is a graphical image of a constellation model, in accordance with embodiments of the present disclosure, shows the constellation for the received Orbital signal, and in particular, the received Orbital signal constellation before averaging. This is the noisy Orbital QPSK signal R_{orbital} after the power scaling block of FIG. 16.

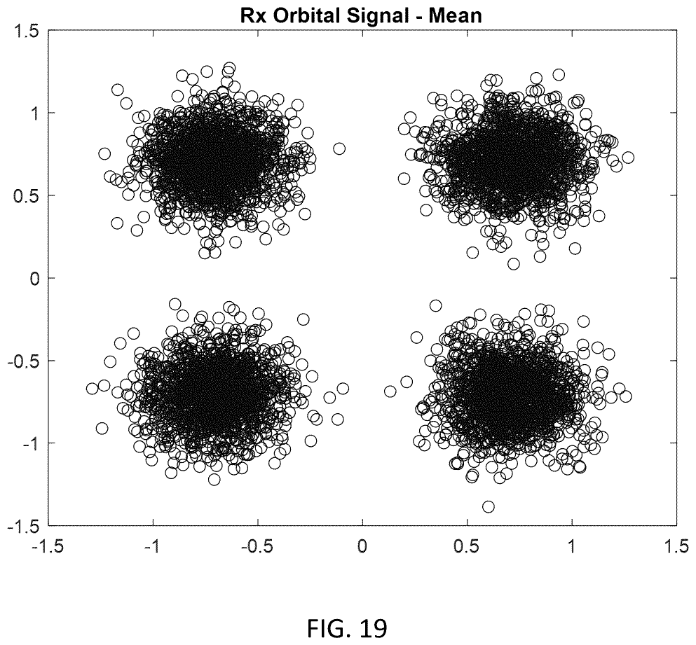

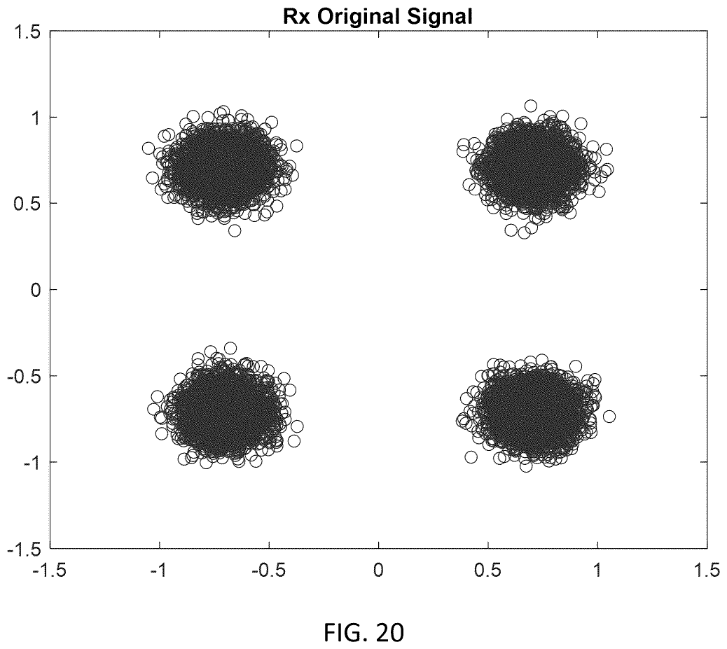

It is noted that the Orbital signal contains the redundant data and that data is averaged to improve the signal to noise ratio. The averaged Orbital signal constellation is shown in FIG. 19, which is a graphical image of a constellation model, in accordance with embodiments of the present disclosure. With the improved signal to noise ratio, the Orbital signals transmitted bits is QPSK demodulated to recover the transmitted bits. The demodulated signal is remodulated and subtracted from the received composite signal to recover the original QPSK signal. The constellation of the original signal is shown in FIG. 20, which is a graphical image of a constellation model, in accordance with embodiments of the present disclosure. Specifically, FIG. 20 illustrates the received Original signal after signal interference cancellation, e.g., the received QPSK signal Rb₁ referenced in FIG. 11.

This signal is QPSK demodulated and the original signal bits are recovered. The bit error rate and error vector magnitude (EVM) results are as follows:

Composite EVM: 42.061%
Rx Original EVM-SIC: 13.246%
Original EVM-AWGN: 12.236%
Rx Orbital EVM: 33.271%
Rx Orbit Mean EVM: 23.535%
Orbital Mean AWGN EVM: 21.543%
Composite BER: 0.000000E+00
Orbital BER: 2.787162E−03
Orbital Mean BER: 0.000000E+00
Original BER-SIC: 0.000000E+00
Original BER-AWGN: 0.000000E+00
Orbital BER-AWGN: 0.000000E+00.

As can be understood, the EVM for the received original signal is only slightly higher when compared to passing just the original signal through an AWGN channel and the same is true for the Orbital signal. The bit error rate results show that both the original and orbital signal are successfully recovered without bit errors.

Relative to this data, it is noted that the composite error vector magnitude is the RMS error value calculated when measuring the error of all of the received noisy points plotted in FIG. 17 relative to the initial ideal points of the transmitted original signal in FIG. 16. The Rx Original EVM-SIC is the EVM calculated when finding the RMS error between the noisy signal plotted in FIG. 20 relative to the ideal transmitted original signal. The Original EVM-AWGN is the EVM for the same original signal passed through a AWGN noisy channel without the additional Orbital signal to compare the EVM of the Signal Interference Cancelled Original signal to. The Rx Orbital EVM is the error calculated from the noisy signal in FIG. 18 relative to the ideal signal plotted in FIG. 12. The Rx Orbital Mean EVM is the error calculated from the noisy signal in FIG. 19 relative to the ideal signal plotted in FIG. 12. The Orbital Mean AWGN EVM is the EVM of the power scaled orbital signal sent through a AWGN channel with the same SNR and the same averaging was taken to compare against the EVM of the Rx Orbital Mean EVM. The bit error rates for each of the Composite, Orbital, Orbital mean, and Original SIC are calculated by comparing the number of errors in the received bits relative to their counterpart transmitted bits. The same signals used to calculate the AWGN EVMs were used to calculate and compare the bit error rates to their counterpart signals.

It is noted that the system 10 could be implemented using two separate software defined radios with a hardware attenuator added to the transmitter chain, however, this implementation may be less preferable. In this possible implementation, the original radio would remain unchanged while the second radio would be modified to transmit repeated sets of data. The transmitter could then remain unchanged with the addition of a hardware attenuator to the transmit chain. The receiver could then be tapped for data before and after the demodulator and the described signal processing could be done on the received data from that point. The demodulated received data would be remodulated and subtracted from the received modulated data. The resultant signal would be the noisy additional signal and that signal would be averaged to improve the signal to noise ratio. That signal would then be subtracted from the original signal and demodulated to get the interference cancelled original signal.

It is also noted that the system 10 can provide advantages in secure RF signal transmission and obfuscation of RF signals, in particular, for the additional signal(s). This is due to the fact that the signals are at a lower power than the original signal and will be unrecoverable without the digital signal processing required to cancel the interference and improve the signal to noise ratio. The additional signal can also be used to securely transmit a control channel or encryption keys.

Moreover, with regards to signal obfuscation, it is noted that obfuscated communications are further provided by the waveform structure of the added TM signals since they resemble noise and distortion. In addition, techniques such a Unitary Braid Division Multiplexing (UBDM) further obfuscates the added TM signals by transforming them from a Gaussian noise distribution, making them difficult to detect or intercept. UBDM is a transformation applied to the baseband samples of a communication signal. The algorithm functions as a symmetric key block cipher operating on baseband I/Q. It supports key sizes of 128, 192, and 256 bits. The technique also provides “Zero Probability of Interception” (ZPI), meaning interception by an unintended recipient is cryptographically hard, requiring work equivalent to or greater than full key exhaust. In other words, even with full system knowledge, a large corpus of matched plain/cipher pairs, perfectly synchronized and equalized signal collection with arbitrarily high signal-to-noise ratio, and very large computing resources and available man-hours, an adversary has no better attack than brute-force key exhaust to recover the actual modulated bits.

It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure. Any number of additional steps, functions, processes, or variants thereof may be included in the method, including any disclosed relative to any other figure of this disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for enhanced radio frequency (RF) communications, the method comprising:
transmitting, with a transmitter, a first RF signal to a receiver through at least one RF channel having a spectral mask;
modulating, in the transmitter, at least a second RF signal;
transmitting, with the transmitter, the modulated second RF signal to the receiver through at least one RF channel, and wherein the modulated second RF signal is transmitted at a same time and frequency as the first RF signal;
receiving, at the receiver, the first RF signal and the modulated second RF signal at the same time;
demodulating the modulated second RF signal at the receiver; and
cancelling, at the receiver, signal interference between the first RF signal and the second RF signal.

2. The method of claim 1, wherein the second RF signal further comprises a plurality of second RF signals.

3. The method of claim 1, wherein the transmitter and the receiver are in a software defined radio.

4. The method of claim 1, wherein transmitting, with the transmitter, the modulated second RF signal to the receiver further comprises transmitting the modulated second RF signal to the receiver at a lower power level than a power level of the first RF signal.

5. The method of claim 1, further comprising:
and the second RF signal;
bit mapping the data set of the second RF signal; and
passing the data set of the second RF signal through a digital signal processing (DSP) block, whereby outputting at least one digital signal corresponding to the second RF signal.

6. The method of claim 5, further comprising processing the at least one digital signal corresponding to the second RF signal in a digital-to-analog (DAC) converter, an interpolator, and an up converter to create a time domain signal on the TM channel.

7. The method of claim 6, further comprising combining a plurality of digital signals corresponding to a plurality of second RF signals before processing in the digital-to-analog (DAC) converter, the interpolator, and the up converter.

8. The method of claim 5, wherein passing the data set of the second RF signal through the DSP block further comprises:
inputting the data sets with FEC into the DSP block by:
delaying the data set corresponding to the first RF signal; and
passing the data set corresponding to the second RF signal through a redundancy block, thereby processing the data set of the second RF signal into smaller blocks of data; and
repeating the smaller blocks of data from the second RF signal to create new sets of data in additional RF signals, wherein the new sets of data are a same size as the data set of the second RF signal.

9. The method of claim 8, further comprising modulating the first RF signal, the second RF signal, and the additional RF signals to produce digital time domain baseband signals.

10. The method of claim 9, further comprising:
adding the modulated first RF signal, second RF signal, and the additional RF signals; and
processing the added modulated first RF signal, second RF signal, and the additional RF signals in a single DAC.

11. The method of claim 1, wherein demodulating the modulated second RF signal at the receiver further comprises:
receiving a single digital signal corresponding to the first RF signal and the modulated second RF signal;
demodulating the digital signal corresponding to the first RF signal and the modulated second RF signal; and
cancelling signal interference between the first RF signal and the second RF signal by:
remodulating the digital signal corresponding to the first RF signal and the modulated second RF signal using a matching modulation of the transmitter;
subtracting the remodulated digital signal from the received digital signal, thereby substantially canceling the first RF signal from the digital signal;
reducing noise from additional RF signals in the digital signal with an averaging block to produce an averaged signal; and
demodulating the averaged signal with the matching modulation of the transmitter.

12. A system for enhanced radio frequency (RF) communications comprising:
a software defined radio having a transmitter and a receiver in communication through at least one RF channel, the software defined radio executing instructions for:
transmitting, with the transmitter, a first RF signal to the receiver through the at least one RF channel having a spectral mask;
modulating, in the transmitter, at least a second RF signal;
transmitting, with the transmitter, the modulated second RF signal to the receiver through at least one RF channel, and wherein the modulated second RF signal is transmitted at a same time and frequency as the first RF signal;
receiving, at the receiver, the first RF signal and the modulated second RF signal at the same time;
demodulating the modulated second RF signal at the receiver; and
cancelling, at the receiver, signal interference between the first RF signal and the second RF signal.

13. The system of claim 12, wherein the second RF signal further comprises a plurality of second RF signals.

14. The system of claim 12, wherein transmitting, with the transmitter, the modulated second RF signal to the receiver further comprises transmitting the modulated second RF signal to the receiver at a lower power level than a power level of the first RF signal.

15. The system of claim 12, further comprising:
and the second RF signal;
bit mapping the data set of the second RF signal; and
passing the data set of the second RF signal through a digital signal processing (DSP) block, whereby outputting at least one digital signal corresponding to the second RF signal.

16. The system of claim 15, further comprising:
processing the at least one digital signal corresponding to the second RF signal in a digital-to-analog (DAC) converter, an interpolator, and an up converter to create a time domain signal on the RF channel; and
combining a plurality of digital signals corresponding to a plurality of second RF signals before processing in the digital-to-analog (DAC) converter, the interpolator, and the up converter.

17. The system of claim 15, wherein passing the data set of the second RF signal through the DSP block further comprises:
inputting the data sets with FEC into the DSP block by:
delaying the data set corresponding to the first RF signal; and
passing the data set corresponding to the second RF signal through a redundancy block, thereby processing the data set of the second RF signal into smaller blocks of data; and
repeating the smaller blocks of data from the second RF signal to create new sets of data in additional RF signals, wherein the new sets of data are a same size as the data set of the second RF signal.

18. The system of claim 17, further comprising:
modulating the first RF signal, the second RF signal, and the additional RF signals to produce digital time domain baseband signals;

19. The system of claim 18, further comprising
adding the modulated first RF signal, second RF signal, and the additional RF signals; and
processing the added modulated first RF signal, second RF signal, and the additional RF signals in a single DAC.

20. The system of claim 12, wherein demodulating the modulated second RF signal at the receiver further comprises:
receiving a single digital signal corresponding to the first RF signal and the modulated second RF signal;
demodulating the digital signal corresponding to the first RF signal and the modulated second RF signal; and
cancelling signal interference between the first RF signal and the second RF signal by:
remodulating the digital signal corresponding to the first RF signal and the modulated second RF signal using a matching modulation of the transmitter;
subtracting the remodulated digital signal from the received digital signal, thereby substantially canceling the first RF signal from the digital signal;
reducing noise from additional RF signals in the digital signal with an averaging block to produce an averaged signal; and
demodulating the averaged signal with the matching modulation of the transmitter.
